(19) United States
(12) Patent Application Publication
(10) Pub. No.: US 2013/0032534 A1
(43) Pub. Date: Feb. 7, 2013

(54) DENITRIFICATION PROCESS FOR REMEDIATION OF CONTAMINATED GROUNDWATER AND SOIL

(71) Applicants: SCOTT B. WILSON, Leucadia, CA (US); BENJAMIN V. MORK, Newport Beach, CA (US)

(72) Inventors: SCOTT B. WILSON, Leucadia, CA (US); BENJAMIN V. MORK, Newport Beach, CA (US)

(21) Appl. No.: 13/564,630

(22) Filed: Aug. 1, 2012

Related U.S. Application Data
(60) Provisional application No. 61/514,131, filed on Aug. 2, 2011.

(51) Int. Cl. B09C 1/08; C02F 9/04; C02F 9/14

(52) U.S. Cl. 210/631; 405/128.75

(57) ABSTRACT

Processes for removing hydrocarbon contaminants from soil and groundwater via enhanced biological denitrification. A contamination zone of groundwater and/or soil is identified to define a volume or zone of contaminants to be treated. A source of nitrate is applied to the contaminant zone to serve as an electronic acceptor for enhanced bioremediation of the petroleum hydrocarbons. A further carbon source, secondary to the primary contaminant hydrocarbons, is added to form a barrier about the nitrate treatment zone to stimulate degradation of any nitrate migrating from the treatment zone. A further carbon source is also added to stimulate the degradation of any residual nitrate once the primary carbon source of the contaminant hydrocarbons have been destroyed.

### CROSS-REFERENCE TO RELATED APPLICATIONS

The present application claims priority to U.S. Provisional Patent Application Ser. No. 61/514,131, entitled DENITRIFICATION PROCESS FOR REMEDIATION OF CONTAMINATED GROUNDWATER AND SOIL, filed Aug. 2, 2011.

### STATEMENT RE: FEDERALLY SPONSORED RESEARCH/DEVELOPMENT

Not Applicable

### BACKGROUND

Hydrocarbon contamination exists in groundwater and soil at thousands of sites around the world. This contamination is often the result of accidental release of fuels (e.g. gasoline or diesel fuel) from storage, transport, or transfer devices including but not limited to storage tanks, pipelines, dispenser pumps, rail cars, and tank trucks. This petroleum contamination often presents a health risk to humans or local ecological systems, therefore it is desirable to destroy or remove the contamination.

Groundwater is a valuable natural resource due to its use as drinking water in many areas, as well as its importance in ecology and natural water cycles. In order to protect natural resources and rehabilitate contaminated groundwater, many technologies exist for removal or destruction of petroleum hydrocarbon contamination in groundwater and soil. Treatment methods range from simple physical removal and disposal of contaminated soil and water to more complex methods such as destruction of contaminants by natural or enhanced biodegradation (bioremediation) or chemical transformation. In particular, bioremediation has been used extensively to remediate sites contaminated with petroleum hydrocarbons in a cost effective manner.

Bioremediation of hydrocarbons typically involves microbial oxidation of the petroleum constituents into carbon dioxide and water and requires an electron acceptor to act indirectly as an oxidant in the process. Suitable electron acceptors include but are not limited to oxygen, sulfate, and nitrate. Although the specific bacteria and mechanisms differ for each electron acceptor, one may add any of these electron acceptors to stimulate bioremediation of petroleum hydrocarbons in soil and water mixtures.

Addition of oxygen by slow-releasing chemicals has been used extensively and successfully in-situ for almost 20 years. The materials that provide a slow-releasing source of oxygen are typically based on magnesium peroxide or calcium peroxide.

Alternatively, nitrate or sulfate can be used as electron acceptors. Both are available at significantly lower costs than alkaline earth peroxides, and have the advantage of being very soluble in water, which allows them to distribute widely underground through soil and groundwater.

The process of denitrification involves biological conversion of nitrate or other nitrogen oxides into dinitrogen (N2). In remediation of petroleum-impacted groundwater, addition of nitrate stimulates the dentirification process whereby the hydrocarbon contaminant is consumed as an electron donor for biological reduction of the nitrate.

Although nitrate is a low-cost, soluble amendment that is easily applied to groundwater, the inherent toxicity of nitrate is generally a problem hindering its utility for groundwater remediation projects. The U.S. government regulates that nitrate should not exist in concentrations higher than 10 mg/L (as nitrogen), and it is impractical and inefficient to apply and distribute sufficient quantities of nitrate in groundwater without exceeding this concentration threshold. There therefore exists a need for technologies that allow controlled, safe use of nitrate in groundwater for petroleum hydrocarbon remediation. It would be of great use to practitioners to be able to use excess nitrate for remediation without the risk of polluting nearby clean groundwater with nitrate and without leaving residual nitrate in groundwater after the remediation project is finished. It is also desirable to prevent the migration of nitrate out of the targeted treatment zone during and after the denitrification process.

### BRIEF SUMMARY

The present invention specifically addresses and alleviates the above-identified deficiencies in the art. Specifically, the present invention is drawn to denitrification processes that are applied for the remediation of groundwater and soil that are contaminated with hydrocarbons. Such processes comprise the initial step of identifying a location or zone of groundwater and/or soil and staking out the boundaries thereof so as to define a three dimensional area having a corresponding volume. In this regard, there is initially defined a zone of contamination upon which the processes of the present invention will be applied. Such zone may further expressly encompass flowing groundwater passing through a specific site or area.

Once having defined the zone of contamination, a source of nitrate and a secondary source of carbon (the primary source being the hydrocarbon responsible for causing the contamination within the contamination zone) are selectively introduced in geospatial relation to one another so as to facilitate bioremediation via denitrification. In this regard, the nitrate is introduced into the contamination zone containing the undesirable petroleum hydrocarbons to act as an electronic acceptor to enhance bioremediation. Examples of suitable nitrate sources include sodium nitrate, potassium nitrate, calcium nitrate, and nitric acid, and are introduced into the contamination zone in an amount ranging from 1 to 100,000 mg/L (as nitrogen), and more preferably between 10 mg/L and 10,000 mg/L.

The secondary source of carbon, in contrast, is selectively introduced about the perimeter of the contamination zone or at least a portion thereof to essentially define a barrier. In this regard, the purpose of the secondary carbon source is to contain the nitrate to the contamination zone where it is desired, as well as to enhance degradation of any residual nitrate after the petroleum hydrocarbons—the primary carbon source and source of contamination—has been destroyed. The secondary carbon source can comprise anything that can be microbiologically metabolized to stimulate anaerobic conditions. Exemplary of such compositions include molasses, sodium lactate, lactic acid, vegetable oil, polylactate esters and combinations thereof, including other well-known organic materials known in the art. Such secondary carbon source will be introduced about the perimeter of the contamination zone, or at least a portion thereof in an amount ranging from 100 to 100,000 mg/L, and more preferably from 500 to 10,000 mg/L. In operation, the zone of the secondary carbon source, despite being permeable to water, facilitates the creation of anaerobic conditions that are consequently caused by fermentation of the secondary carbon source which, in turn, ensures that the nitrates passing through the contamination zone are sufficiently degraded. In this respect, the secondary carbon zone is operative to define a zone that destroys escaping nitrates.

In further refinements of the invention, both the nitrates and secondary carbon source may be introduced into the contamination zone in either bulk form or by the periodic introduction of such components according to a timed schedule. In this regard, both the nitrate and secondary carbon source may be introduced via a variety of methods known in the art such as by direct push injection, injection into wells, in-situ soil mixing, feeding into infiltration galleries, or direct application into open excavation pits.

Moreover, the relative amounts of the nitrate and secondary carbon can be determined to the exercise of ordinary skill based upon the volume of contaminated groundwater and soil to be treated, the concentration of hydrocarbons contaminating the groundwater/soil and the stoichiometric amounts of such materials as is needed to accommodate anticipated biological consumption by the micro-organisms that will effectuate the biological degradation of the contaminates and thus effectuate bioremediation. To that end, the processes described herein will include monitoring of the contaminant-removing denitrification processes and, if warranted, adjusting the nitrate/secondary carbon source application as necessary until the contaminants are sufficiently removed.

### BRIEF DESCRIPTION OF THE DRAWINGS

These and other features and advantages of the various embodiments disclosed herein will be better understood with respect to the following description and drawings, in which like numbers refer to like parts throughout.

FIG. 1 is a flowchart diagram depicting the steps for facilitating denitrification in groundwater and soil contaminated with hydrocarbons, according to a preferred embodiment of the present invention.

FIG. 2 is a top view of a body of flowing groundwater being treated in accordance with a preferred embodiment of the present invention.

FIG. 3 is a top view of an isolated body of contaminated groundwater being treated in accordance with an alternative preferred embodiment according to the present invention.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

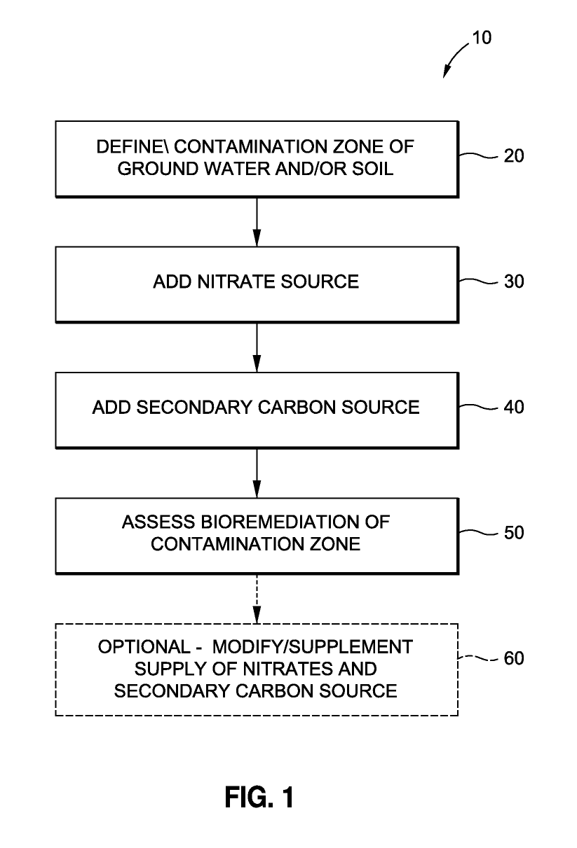

Referring now to FIG. 1, there is shown a diagram of the steps for performing the processes of the present invention according to a preferred embodiment. As illustrated, the process 10 comprises the initial step 20 of defining a contamination zone of soil and/or groundwater sought to be treated by the processes of the present invention. In this regard, such zone will be defined by an area, thickness and depth of soil and/or groundwater that contains the hydrocarbon contaminants sought to be removed. It is contemplated that the contamination zone will essentially be an area that is staked out and will define a surface area and depth, and hence a volume, upon which the processes of the present invention will be practiced. To that end, it is contemplated that any of a variety of means may be deployed that are known in the art that can identify the degree and extent of hydrocarbon contamination in soil and/or groundwater. For example, it is contemplated that the contamination zone may be determined via random sampling of soil and water samples about a given area that can be used to map out defined boundaries and depth which will thus correspond to the zone or volume to be treated.

As will be appreciated by those skilled in the art, the process of identifying a contamination zone 20 may involve a very small area of soil and/or groundwater or, alternatively, can involve contamination of a substantial volume of soil and/or groundwater. Depending on the degree of scale, different techniques may be deployed that are readily known and understood by those skilled in the art that can enable the mapping or identification of the boundaries of such contamination zone to be readily determined. Techniques for determination of the quantity and spatial distribution of contamination in soil and groundwater include subsurface soil and groundwater sampling (e.g. by direct push methods) and sampling of groundwater from existing monitoring wells. Zones in which hydrocarbon levels exceed the local or federal allowable limits in groundwater or soil would be suitable for treatment with the present invention. For example, benzene is a specific hydrocarbon molecule and a common constituent of gasoline. The USEPA regulates benzene in groundwater and drinking water to a Maximum Contaminant Level (MCL) of 0.005 mg/L, or 5 ppb. Any groundwater with benzene present above 5 ppb would be suitable for treatment with the current invention. Other, less toxic hydrocarbons are regulated differently within each state and have higher MCLs or similar regulatory limits. Groundwater with acceptable levels of contamination would not necessitate treatment by this invention. Additionally, it is contemplated that the contamination zone can encompass flowing groundwater, and in particular can encompass a particular area or site through which contaminated groundwater passes. In such application, it is contemplated that the contamination zone which defines the target area at which the processes of the present invention are deployed can essentially encompass a pass-through point or zone. Advantageously the contaminated groundwater will become sufficiently treated through the processes herein so as to be sufficiently free of contaminants once exiting the zone within which denitrification is effectuated.

Once having defined the contamination zone in step 20, biological denitrification processes are then deployed to facilitate bioremediation via the biological degradation of the hydrocarbon contaminants. To that end, the present invention deploys the combination of a nitrate source to and a secondary carbon source about the contamination zone defined in step 20. Steps 30 and 40, which introduce these components, respectively provide the biologically necessary components, namely, nitrates and a carbon source, that can facilitate bioremediation via denitrification in a manner that has not hereto for been appreciated.

In this regard, the present invention allows efficient and safe use of nitrate as an electron acceptor for enhanced bioremediation of petroleum hydrocarbons in groundwater and soil. The approach involves applying nitrate to the primary carbon source, namely, the petroleum hydrocarbon contamination, with a secondary non-toxic carbon source being supplied and positioned about the area to be treated. The purpose of the secondary carbon source is to act as a barrier to contain the nitrate to the area where it is dispersed to stimulate the removal of the nitrate in areas where it is desired and to enhance degradation of any residual nitrate after the petroleum hydrocarbons have been destroyed.

Suitable sources of nitrate include water-soluble materials that provide a source of nitrate ion (NO3−) in solution. Examples of suitable nitrate sources include sodium nitrate, potassium nitrate, calcium nitrate, and nitric acid. The range of concentration of nitrate in groundwater for this invention is 1-100,000 mg/L nitrate (as nitrogen). The preferred range of concentration of nitrate in groundwater is between 10 mg/L and 10,000 mg/L.

Suitable secondary carbon sources can be anything that is microbially metabolized in groundwater to stimulate anaerobic conditions. Examples of organic materials commonly used for this purpose include sodium lactate, lactic acid, vegetable oil, and polylactate esters.

The secondary carbon source should be introduced around the perimeter of the contamination zone, or at least a portion thereof, at a concentration ranging from 100 mg/L to 100,000 mg/L. In a more preferred range, the secondary carbon source will be present in an amount of 500 mg/L to 10,000 mg/L.

With respect to the introduction of both the nitrate and secondary carbon source, the same may be achieved by a variety of methods well-known in the art. For example, such components may be applied via direct push injection, injection into wells, in-situ soil mixing, gravity feeding into infiltration galleries or wells, infiltration from surface application, or direct application into open excavation pits. Moreover, it is contemplated that the nitrate and secondary carbon sources can be introduced into the contamination zone either in a bulk, one-time delivery or, alternatively, applied in discreet amounts over a prescribed time frame. For example, it is contemplated that both the nitrate amendment and secondary carbon source can be replenished over time as needed. Furthermore, if the nitrate in the contamination zone is depleted before the contamination has been reduced below desired levels, then it would be appropriate to re-apply the nitrate source in an amount sufficient to destroy the remaining contamination. In the case of the secondary carbon source, its presence can be measured in groundwater (as TOC and/or specific compound analyses, e.g.; lactic acid). If the anaerobic barrier was to be depleted of the secondary carbon source while the nitrate was still present in significant concentration, then the secondary carbon source could be replenished in the barrier to ensure the nitrate remains contained only in the desired zone.

Accordingly, it is contemplated that steps 30 and 40 may be practiced simultaneously or separately, and may either be performed as a single, one-time application or may take the form of several scheduled applications. It is likewise contemplated that steps 30 and 40 may be practiced whereby the secondary carbon source is first deployed to define a barrier zone about the perimeter of the contamination zone or at least a portion thereof. The introduction of nitrates, in contrast, can then be introduced into the contaminated groundwater thereafter, as discussed above. Accordingly, steps 30 and 40 need not be practiced in any set sequential order.

Along those lines, it is contemplated that in most applications it may be necessary or desired to apply the secondary carbon source in a manner that establishes a perimeter about the contamination zone defined in step 20. As discussed above, the contaminant zone will comprise a three dimensional zone of groundwater and/or contaminated soil and may be defined by natural barriers that are operative to confine the nitrates within the contamination zone. However, it is further contemplated that the secondary carbon source may be applied in a manner to define a barrier or perimeter around the contamination zone whereby the secondary carbon source is infused around the contamination zone to prevent migration of nitrates therethrough. As contemplated, the secondary carbon source may be applied in such a manner to define a barrier about a contamination zone via such techniques as direct-push injection into the soil and groundwater; infiltration of a solution of secondary carbon source into wells placed in a barrier configuration about the contamination zone; and/or digging a trench and backfilling with soil or gravel mixed with the secondary carbon source about the contamination zone. In all such applications, there will thus be provided a barrier operative to confine and physically define the parameters of the contamination zone while at the same time enabling groundwater, once having been sufficiently treated to effectuate denitrification, to permeate therethrough. As will be appreciated by those skilled in the art, by providing the secondary carbon source as applied in the barrier configuration around the contamination zone will consequently provide a biological denitrification containment barrier that is operative to prevent nitrate migration away from the contamination zone while at the same time allowing treated groundwater to permeate therethrough.

Following administration of the nitrate and secondary carbon source 30, 40 to and about the contamination zone, the natural bioremediation processes are allowed to proceed whereby the hydrocarbon contaminants are ultimately metabolized. As a consequence of such biological activity, the contamination zone will thus be remediated and ultimately rendered contaminant-free or otherwise have a reduced contaminant level that is suitable to meet certain specifications or attain a desired goal. As part of such process, step 50 is provided whereby the degree of denitrification is monitored and the contaminant levels assessed. As discussed above, once the desired levels of the contaminant have been completely eradicated or attain desirable goals, the process 10 is deemed complete. Along those lines, the supply of secondary carbon source will be provided in an amount sufficient to enhance any degradation of any residual nitrate after the hydrocarbon contaminants have been destroyed.

To the extent the level of contaminants has not reached the desired reduced levels, there is provided optional step 60 which provides for the further addition of nitrates and/or secondary carbon source to thus enable the bioremediation process to continue until such time as the contaminants are sufficiently removed. To that end, it is contemplated that both the nitrate and secondary carbon source may be applied as discussed above and in amounts deemed sufficient to facilitate the degree of denitrification necessary to reduce if not eradicate, the remaining hydrocarbon contaminants. Per the process as discussed above, the amount and application of the nitrate and secondary carbon source components, plus the timing or schedule by which those components are introduced to the contaminant zone may be determined as appropriate to treat a specified contamination zone.

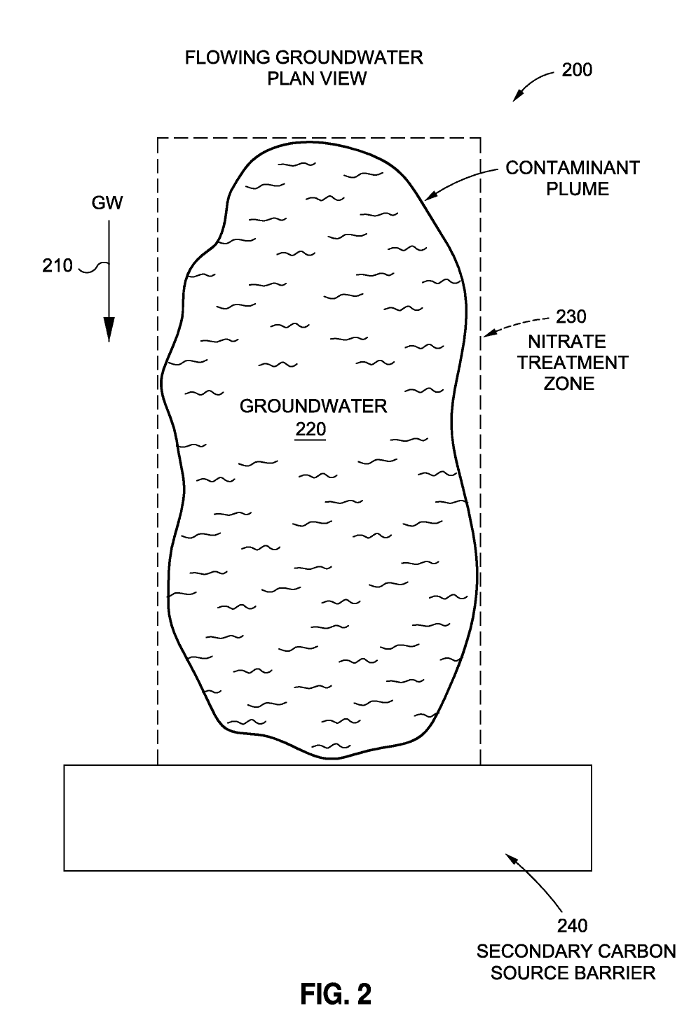

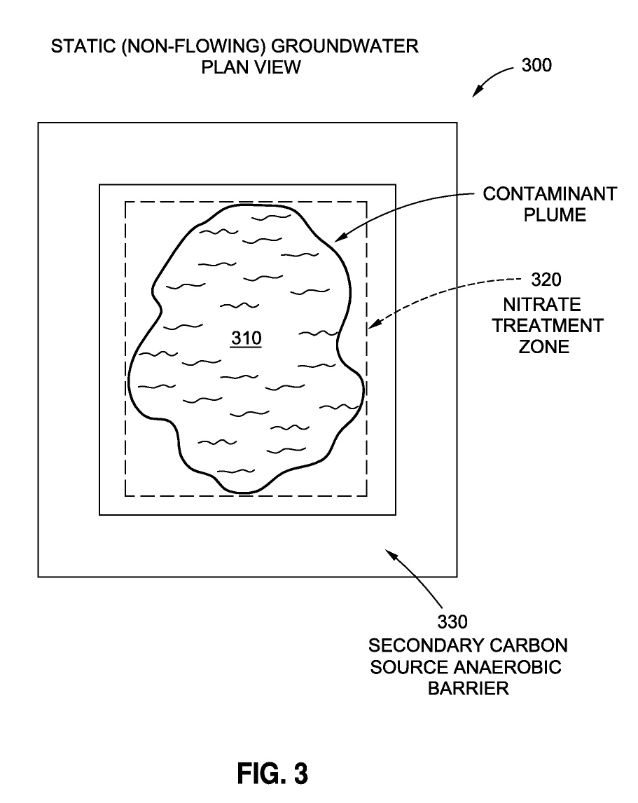

Referring now to FIGS. 2 and 3, there are depicted two exemplary embodiments of the processes of the present invention as utilized to treat contaminated groundwater. Referring initially to FIG. 2, there is shown a process 200 by which a body of contaminated groundwater 220 flowing in the direction 210 is treated via the process of the present invention to effectuate denitrification. As illustrated, a contamination zone or plume is defined about an area of a flowing, continuous body of contaminated groundwater within which nitrates are introduced upstream, to thus define a nitrate treatment zone 230. As discussed above, the nitrates will be sufficiently infused within the contaminated groundwater 220 so as to effectuate a sufficient degree of denitrification.

Formed at a point downstream from the flowing contaminated groundwater treated with nitrates is a barrier 240 defined by a secondary carbon source that is operative to come into contact with the oncoming flow of contaminated groundwater after having been treated with the nitrates. As discussed above, the secondary carbon source, by virtue of being positioned downstream from the point at which the nitrates are introduced into the flowing contaminated groundwater, will be operative to serve as a barrier 240 preventing the nitrates from passing through the secondary carbon source barrier 240 while at the same time enabling the groundwater that has undergone the denitrification process to permeate therethrough. In this regard, the secondary carbon source defining the barrier 240 does not necessarily define a physical barrier preventing the flow of water therethrough, but instead is operative to prevent any excess nitrates not consumed in the denitrification process from passing beyond the contamination zone.

As should be readily appreciated by those skilled in the art, in the embodiment depicted in FIG. 2, the secondary carbon source barrier 240 may alternatively be positioned on one or both sides running parallel to the flow of the contaminated groundwater 210 or, alternatively, may be positioned on one or both sides of the flowing contaminated groundwater in combination with a perpendicularly oriented barrier 240 as depicted. In all such embodiments, it should be understood that the barrier defined by the secondary carbon source will be selectively positioned so as to ultimately come into contact with and prevent any excess nitrates not consumed via the denitrification processes.

Referring now the FIG. 3, there is a top view depicting the deployment of the denitrification process 300 according to the present invention as utilized to treat an isolated body of contaminated groundwater 310. As illustrated, the barrier 330 defined by the secondary carbon source is formed about the perimeter of the contaminated groundwater 310. The nitrates, in turn, are introduced into the contaminated groundwater via zone 320 in order to effectuate the denitrification processes. In this regard, the barrier 330 defined by the secondary carbon source will be operative to confine the nitrates 320 within the contaminated groundwater 310 to a degree sufficient to promote denitrification while at the same time preventing the nitrates from permeating outside of the zone 320. Water that has ultimately been irradicated of hydrocarbons via the denitrification process, however, will be able to permeate through the barrier 330 defined by the secondary carbon source. Ultimately, once the denitrification processes have sufficiently effectuated removal of the primary hydrocarbon contaminants, any such remaining nitrates will sufficiently degrade or be captured within the secondary carbon source barrier 330, at which point the contaminants originally present within the groundwater will have been irradicated and remediation effectuated.

The above description is given by way of example, and not limitation. Given the above disclosure, one skilled in the art could devise variations that are within the scope and spirit of the invention disclosed herein, including various ways of facilitating the bioremediation of groundwater and soil contaminated with hydrocarbons by means of biological denitrification processes. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of treating petroleum-contaminated ground water and accompanying soil comprising the steps:
a. evaluating a site of soil and groundwater contaminated with hydrocarbons and defining a three dimensional contamination zone having a perimeter;
b. applying a source of nitrate to said contamination zone defined in step a) in an amount sufficient to facilitate biological anaerobic oxidation of said hydrocarbons;
c. applying a secondary source of carbon about at least a portion of said perimeter defined by said contamination zone, said secondary carbon source defining a barrier and being provided in an amount sufficient to facilitate degradation of any excess residual nitrate provided in step b) from passing therethrough following degradation of said hydrocarbon contaminants present in said containment zone defined in step a); and
d. monitoring said contaminant zone following the administration of said nitrate in step b) and said secondary carbon source in step c) and confirming said hydrocarbon contaminants present in said contamination zone are sufficiently removed.

2. The method of claim 1 wherein in step b), said nitrate is applied in an amount ranging from 1 to 100,000 mg/L.

3. The method of claim 2 wherein said nitrate is applied in a concentration between 10 mg/L and 10,000 mg/L.

4. The method of claim 1 wherein step a) further comprises establishing a physical barrier about said contamination zone.

5. The method of claim 4 wherein said barrier formed about said contamination zone is formed from said secondary carbon source.

6. The method of claim 5 wherein said barrier formed about said containment zone is formed by direct-push injection of said secondary carbon source into soil and groundwater.

7. The method of claim 5 wherein said barrier is formed by infiltration of a solution of said secondary carbon source into wells placed about the perimeter of said contamination zone.

8. The method of claim 5 wherein said barrier is formed by digging a trench about the perimeter of said containment zone and backfilling said trench with soil or gravel mixed with said secondary carbon source.

9. The method of claim 1 wherein in step c) said secondary carbon source is applied at a concentration from 100 mg/L to 100,000 mg/L.

10. The method of claim 1 wherein in step b), said source nitrate is selected from the group consisting of sodium nitrate, potassium nitrate, calcium nitrate, nitric acid and combinations thereof.

11. The method of claim 1 wherein in step c), said secondary carbon source is selected from the group consisting of soluble carbohydrates, molasses, sodium lactate, lactic acid, vegetable oil, polylactate esters, and combinations thereof.

12. The method of claim 1 wherein in step a), said site contaminated with hydrocarbons comprises an isolated body of groundwater contaminated with hydrocarboms; and wherein in step c), said secondary source of carbon is applied about the perimeter defined by said contamination zone.

13. The method of claim 1 wherein in step a), said site contaminated with hydrocarbons comprises an isolated body of groundwater contaminated with hydrocarboms; and wherein in step c), said secondary source of carbon is applied about a portion of said perimeter defined by said contamination zone.

14. The method of claim 1 wherein in step a), said contamination zone is defined by an area of flowing groundwater contaminated by hydrocarbons; and wherein in step c), said secondary source of carbon is applied perpendicularly to the flow of said groundwater and in geospatial relation to said nitrates applied in step b) such that such barrier defined by said secondary carbon source is downstream relative the site at which said source of nitrates in step b) are applied.

15. The method of claim 14 wherein step c) further includes applying said secondary carbon source parallel to the flow of said contaminated groundwater.

16. The method of claim 1 wherein step c) is performed prior to step b).

17. The method of claim 1 wherein steps b) and c) are performed simultaneously.
